(19) United States
(12) Patent Application Publication
(10) Pub. No.: US 2023/0186360 A1
(43) Pub. Date: Jun. 15, 2023

(54) GENERATING STRUCTURED PREFERENCES FOR ITEM SELECTION FOR DISPLAY IN AN INTERFACE FROM UNSTRUCTURED TEXT PREVIOUSLY PROVIDED TO SHOPPERS BY USERS

(71) Applicant: Maplebear Inc. (dba Instacart), San Francisco, CA (US)

(72) Inventors: Joey Loi, San Francisco, CA (US); Viswa Mani Kiran Peddinti, San Francisco, CA (US); Eugene Agronin, Sunnyvale, CA (US); John Salaveria, San Francisco, CA (US)

(21) Appl. No.: 17/549,774

(22) Filed: Dec. 13, 2021

(51) Int. Cl. G06Q 30/06; G06F 16/33

(52) U.S. Cl. CPC G06Q 30/0613; G06F 16/3334; G06Q 30/0641

(57) ABSTRACT

An online concierge system allows users to add items to an order and provide instructions to a shopper specifying attributes for selecting an item in the order from a warehouse. To simplify entry of the instructions, the online concierge system converts previously received instructions comprising unstructured text into structured suggestions by extracting words from the previously received instructions. The suggestions are associated with items or generic item descriptions. When a user includes an item in an order, the online concierge system displays one or more suggestions associated with the item as selectable options in an interface to simplify specification of instructions for the item.

### BACKGROUND

This disclosure relates generally to fulfilling orders received by an online concierge system, and more specifically to leveraging text provided by a user to a shopper for obtaining an item to generate structured preferences for subsequent selection by users.

In current online concierge systems, shoppers (or “pickers”) fulfill orders at a physical warehouse, such as a retailer, on behalf of customers as part of an online shopping concierge service. An online concierge system provides an interface to a customer identifying items offered by a physical warehouse and receives selections of one or more items for an order from the customer. In current online concierge systems, the shoppers may be sent to various warehouses with instructions to fulfill orders for items, and the shoppers then find the items included in the customer order in a warehouse.

As a shopper, rather than the user from whom an order is received, an online concierge system allows a user to provide notes or instructions for an item included in an order. The notes or instructions allow the user to specify preferences for the item for the shopper to refer to when obtaining the item from a warehouse. For example, a user provides notes specifying a firmness or a color of a vegetable included in an order. As another example, a user provides notes specifying a thickness for slices or meat or cheese included in the order. This allows the user to convey the user's preferences to a shopper fulfilling an order, allowing the shopper to select items satisfying the user's preferences.

However, conventional online concierge systems rely on a user entering a text description for different items included in an order. This increases the amount of time for the user to create an order from the user having to compose notes or instructions for different items. Further, as different users may differently describe similar preferences for items, order fulfillment time is increased from shoppers reviewing and interpreting preferences for an item specified by different users.

### SUMMARY

An online concierge system retrieves previously received orders from various users. At least a set of the previously received orders include instructions for one or more items included in a previously received order. An instruction for an item specifies one or more attributes the user desires for the item. In various embodiments, instruction for an item includes unstructured text received from the user specifying the one or more attributes of the item. A previously received order stores an instruction in association with the item for which the instruction was received; for example, a previously received order stores an instruction in association with an item identifier that uniquely identifies the item.

While providing instructions for an item allows a user to tailor items obtained by a shopper when fulfilling an order to preferences of the user, entry of unstructured text to provide instructions for the item is time consuming for the user. Additionally, using unstructured text to specify instructions often results in different users identifying similar attributes in different ways, increasing a time for a shopper to determine an attribute of an item when obtaining the item from a warehouse. Further, using unstructured text for specifying instructions to a shopper provides the shopper with unclear instructions when the shopper and the user are fluent in different languages, with translations between instructions provided by the user to a language of the shopper potentially introducing discrepancies or errors between the instructions provided by the user and the content presented to the shopper. To simplify specification of instructions by users and interpretation of the instructions by shoppers, the online concierge system retrieves instructions previously received for various items from the previously received orders. For example, the online concierge system identifies item identifiers of items included in previously received orders, such as previously received orders received during a specific time interval, associated with instructions received from one or more users.

For an item for which instructions were previously received, the online concierge system extracts one or more specific words from the instructions for the item. For example, the online concierge system extracts specific words occurring in at least a threshold percentage of instructions previously received for the item or occurring with at least a threshold frequency in instructions previously received for the item. In various embodiments, the online concierge system applies one or more natural language processing methods to unstructured text included in different instructions to extract specific words from various instructions received for the item. Alternatively, one or more reviewers of the online concierge system review instructions previously received for the item and extract specific words based on rates at which the specific words occur in instructions previously received for the item. In various embodiments, the online concierge system extracts one or more specific words from instructions previously received for various items. One or more specific words extracted from instructions previously received for an item are stored in association with an item identifier of an item for which the instructions were previously received. Hence, the online concierge system maintains specific words extracted from instructions for various items included in previously received orders by analysis of the instructions previously received for the items.

In various embodiments, the online concierge system identifies words in instructions previously received for various items included in previously received orders and maps words to a uniform terminology. For example, the online concierge system maintains a mapping for various words that maps multiple words to a standardized word, allowing the identification and extraction of specific words in the received instructions to account for variations in how different users identify an attribute of an item. For example, the mapping maintains mappings between a standardized word and one or more synonyms for the standardized word. The synonyms for the standardized word may be identified by one or more users as words or phrases having a common meaning as the standardized word in various embodiments. Words or phrases identified as a synonym for a standardized word may account for an item for which the words or phrases were received; for example, different descriptions of characteristics indicating different items are mapped to a standardized word of “ripe” in various embodiments. Hence, when the online concierge system identifies one of the synonyms in an instruction, the online concierge system maps the synonym and extracts the standardized word rather than the synonym. This allows the online concierge system to standardize the words extracted from different instructions, accounting for variations in how different users identify attributes of an item so the extracted words are in a uniform terminology, simplifying subsequent review and understanding by users and shoppers.

The online concierge system stores words extracted from previously received instructions for the item in association with the item as suggestions. Each suggestion comprises structured text that includes one or more of the words extracted from previously received instructions for the item. When the online concierge system maps extracted words from previously received instructions to standardized words in a uniform terminology, the online concierge system stores the standardized words corresponding to the words extracted from the previously received instructions in association with the item. This allows the online concierge system to leverage previously received instructions in unstructured text for various items to generate and store suggestions that are structured text including one or more words in association with the item for which the one or more words were previously included in instructions.

In some embodiments, for the item, the online concierge system obtains a shopper-specific description for a word stored in association with the item and in association with the word. The shopper-specific description provides details of the item that indicate attributes of the physical item that satisfy the stored word. For example, the word “ripe” is stored in association with an item of produce and a shopper-specific description for “ripe” identifies physical attributes of the item of produce that indicate ripeness. As different items have different physical characteristics that satisfy a word stored in association with the item, storing shopper-specific descriptions in association with a combination of an item and a word stored with the item allows the online concierge system to display shopper-specific descriptions to a shopper for the combination of the item and the word, providing the shopper with a clear description of how to identify an item that has one or more attributes corresponding to the word. By storing the shopper-specific description in association with the combination of the word and the item, the online concierge system simplifies specification of an instruction for the item by the user, allowing the user to specify the word associated with the item, without increasing complexity for the shopper by displaying the shopper-specific description for the combination of the item and the word to the shopper.

The online concierge system compares a word stored in association with the item to words stored in association with the one or more alternative items connected to a common generic item description as the item. In response to determining the word is stored in association with at least a threshold percentage or at least a threshold number of alternative items, the online concierge system stores the word in association with the generic item description that is connected to the item and to the alternative items. In other embodiments, the online concierge system extracts words from instructions previously received for the alternative items, as further described above, and compares the extracted words for the alternative items to the word stored in association with the item. In response to determining the word stored in association with the item was extracted from instructions received for at least a threshold number or at least a threshold percentage of the alternative items connected to a common generic item description as the item, the online concierge system stores the word in association with the generic item description. Subsequently, words stored in association with a generic item description are propagated to each item in a lower level of the taxonomy than the generic item description that are connected to the generic item description, allowing the online concierge system to leverage words extracted from an item for use with other items identified by the taxonomy has having one or more common characteristics with the item.

After storing the extracted words in association with corresponding items, the online concierge system receives a selection of an item for inclusion in a received order from a user. Additionally, the online concierge system receives a request from the user to provide instructions for obtaining the selected item. In response to the request to provide instructions for obtaining the selected item, the online concierge system retrieves one or more suggestions that each include one or more words stored in association with the selected item, or in association with a generic item description to which the selected item is connected via the taxonomy and generates suggestions for the user. In various embodiments, the online concierge system retrieves the suggestions by identifying words stored in association with the item that were extracted from at least a threshold number of in a threshold percentage of instructions previously received for the item. In another embodiment, the online concierge system retrieves the suggestions by ranking words stored in association with the item based on corresponding frequencies with which the stored words were extracted from instructions previously received for the item and retrieving suggestions as stored words having at least a threshold position in the ranking.

The online concierge system transmits the suggestions to the client device of the user for display in an interface for providing instructions for obtaining the selected item. In various embodiments, the interface includes a text entry field that allows the user to provide unstructured text data as an instruction and displays one or more elements that each display and describe a suggestion. The suggestions may be displayed in a sequence based on one or more criteria in various embodiments. For example, the suggestions are displayed in a sequence based on their frequency of selection by the user, or by other users (e.g., users having one or more common characteristics as the user), with suggestions that are more frequently selected having higher positions in the sequence in various embodiments. However, in other embodiments, the suggestions are displayed in a sequence based on their likelihood of selection by the user (or by other users having one or more common characteristics with the user). As another example, the suggestions are displayed in a sequence based on whether the suggestions correspond to words stored in association with the item or stored in association with a generic item description in the taxonomy to which the selected item is connected, with suggestions corresponding to words stored in association with the item having higher positions in the sequence. The online concierge system may reposition suggestions in the sequence over time based on a frequency with which the user or other users selects different suggestions, allowing the suggestions to be displayed in a sequence where more frequently selected suggestions are more readily accessible. In response to receiving a selection of an element corresponding to a suggestion from the user, the online concierge system stores the selected suggestion in association with the selected item of the order. Hence, rather than manually entering text to provide an instruction, the interface transmitted by the online concierge system allows the user to select a selectable element corresponding to one or more words extracted from previously received instructions from the user, reducing an amount of input from the user to specify instructions for obtaining the selected item.

When a shopper selects the order for fulfillment, the online concierge system transmits one or more extracted words corresponding to the selected selectable element as instructions for obtaining the selected item of the order to a client device of the shopper for display. For example, the instructions for obtaining the selected item are displayed to the shopper via an interface of a shopper mobile application via the client device of the shopper in conjunction with the selected item or in conjunction with information identifying the selected item. In some embodiments, the online concierge system transmits shopper-specific directions associated with the one or more extricated words corresponding to the selected selectable element rather than the one or more extracted words corresponding to the selected selectable element. Hence, the online concierge system provides the shopper with more detailed information for obtaining the selected item and providing shoppers with uniform information for how to obtain the item for the user rather than different instructions created by different users.

The online concierge system may modify the words stored in association with an item based on interactions by users with suggestions corresponding to the words that are displayed to users. For example, the online concierge system determines a number of times various suggestions for an item have been displayed to users, such as a number of times different suggestions have been displayed to users during a specific time interval. Additionally, the online concierge system determines a number of times different suggestions for the item have been selected and determines a frequency with which different suggestions for the item have been selected by one or more users. For example, the online concierge system 102 determines a ratio of a number of times a suggestion for an item was selected by users during a time interval to a number of times the suggestion was displayed to users during the time interval for each of a set of suggestions. The online concierge system removes stored associations between the item and between words corresponding to suggestions having less than a threshold ratio in some embodiments. Alternatively, the online concierge system ranks suggestions based on the determined ratios and removes stored associations between the item and words corresponding to suggestions having less than a threshold position in the ranking. This allows the online concierge system to modify stored associations between words corresponding to suggestions displayed to users and an item based on frequencies with which users interact with displayed suggestions for the items, allowing for more efficient use of storage resources of the online concierge system and simplifying selection of one or more suggestions for obtaining an item by limiting subsequent display of suggestions to suggestions that were selected with at least a threshold frequency.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart of a method for generating suggestions comprising structured text identifying attributes of an item for selection by a user when creating an order, according to one embodiment.

FIG. 5 is a process flow diagram of an online concierge system generating suggestions comprising structured text identifying attributes of an item for selection by a user when creating an order, according to one embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

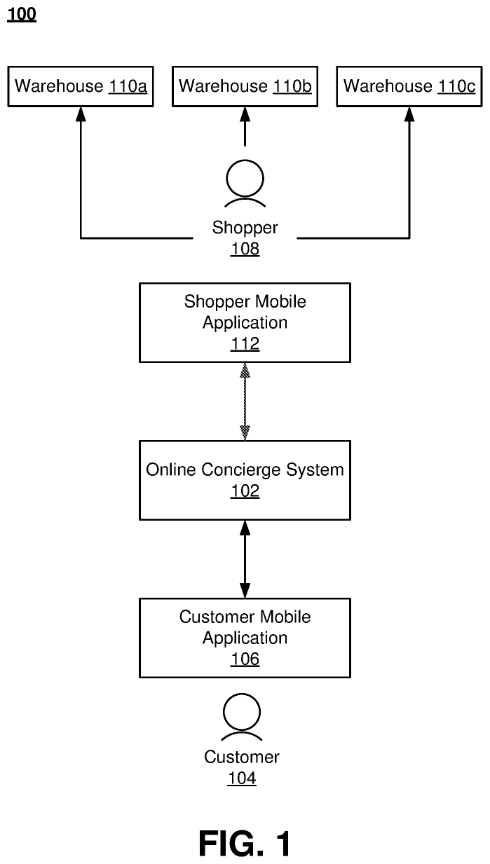

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more customers 104, also referred to herein as “users” (only one is shown for the sake of simplicity). An order specifies a list of goods (items or products) to be delivered to the customer 104 (or “user”). The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more shoppers 108. A shopper 108 may be a contractor, employee, or other person (or entity) who is enabled to fulfill orders received by the online concierge system 102. The shopper 108 travels between a warehouse and a delivery location (e.g., the customer's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to customers. Each shopper 108 fulfills an order received from the online concierge system 102 at one or more warehouses 110, delivers the order to the customer 104, or performs both fulfillment and delivery. In one embodiment, shoppers 108 make use of a shopper mobile application 112 which is configured to interact with the online concierge system 102.

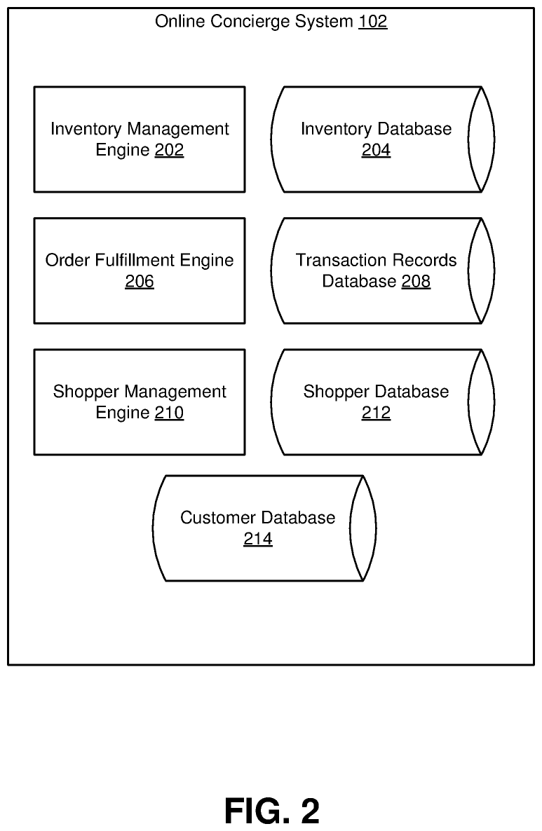

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

The inventory management engine 202 receives an item catalog from a warehouse 110 identifying items offered for purchase by the warehouse 110. The item catalog identifies different items offered by the warehouse 110 and includes attributes of each item. One attribute of an item is a location of the item within the warehouse 110. For example, the item catalog includes an aisle within the warehouse 110 or a department within the warehouse 110 for an item. Various other attributes may be included for an item in the item catalog, allowing the warehouse 110 to provide any suitable information about items offered by the warehouse to the online concierge system 102 via the item catalog. The item catalog for a warehouse 110 is stored in the inventory database 204 in association with an identifier of the warehouse 110.

In various embodiments, the inventory management engine 202 maintains a taxonomy of items offered for purchase by one or more warehouses 110. From the item catalog, the inventory management engine 202 determines a taxonomy of items offered by the warehouse 110. Different levels in the taxonomy provide different levels of specificity about items included in the levels. For example, the taxonomy includes different categories for items, with categories in different levels of the taxonomy providing different levels of specificity for categories, with lower levels in the hierarchy corresponding to more specific categories, and the lowest level of the hierarchy identifying different specific items. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from a warehouse 110 in various embodiments. In other embodiments, the inventory management engine 202 applies a trained classification module to an item catalog received from a warehouse 110 to include different items in levels of the taxonomy, so application of the trained classification model associates specific items with generic item descriptions corresponding to levels within the taxonomy.

In various embodiments, the inventory management engine 202 also receives a layout from the warehouse 110, with the layout identifying different locations within the warehouse 110 relative to each other. For example, the layout is a map of the warehouse 110, with different aisles or departments identified in the map, allowing the map to identify relative positions of aisles or departments to each other within the warehouse 110. The inventory management engine 202 receives an updated layout from the warehouse 110 if the warehouse 110 changes locations of items within the warehouse 110 or rearranges locations in the warehouse 110 relative to each other. In various embodiments, the layout for a warehouse 110 is stored in the inventory database 204 in association with an identifier of the warehouse 110.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a customer 104. Prices set by the order fulfillment engine 206 may or may not be identical to in-store prices determined by retailers (which is the price that customers 104 and shoppers 108 would pay at the retail warehouses). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

The order fulfillment engine 206 transmits an ordering interface to a client device of a user that is displayed to the user in a customer mobile application 106. The ordering interface receives a selection of a warehouse 110 from a user identifying a warehouse 110 for fulfilling an order. Additionally, the ordering interface receives selections of items offered by the identified warehouse 110 by the user for inclusion in the order. When the user selects an item, the ordering interface includes one or more elements that, when accessed by the user, prompt the user to provide instructions specifying attributes of the item for a shopper to purchase. This allows the user to identify specific attributes of an item for a shopper to look for when obtaining the item from the identified warehouse 110.

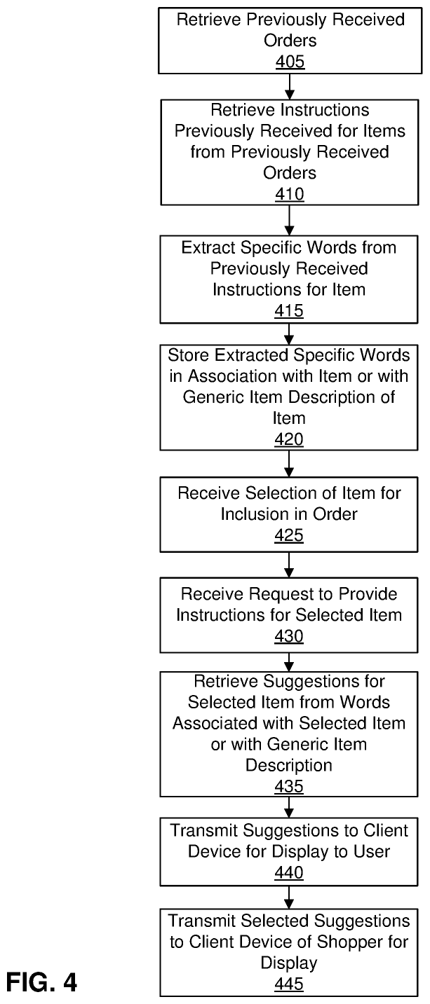

From instructions previously received from users for various items, the order fulfillment engine 206 generates structured data from text of the previously received instructions. As further described below in conjunction with FIG. 4, the order fulfillment engine 206 extracts keywords or phrases from instructions received from shoppers for various items and generates suggestions that each comprise structured text including one or more of the keywords of phrases. The order fulfillment engine 206 associates suggestions with one or more items, such as one or more items for which the keywords or phrases comprising the suggestion were received in instructions with at least a threshold frequency. Subsequently, when the user selects an interface to provide instructions for an item included in an order and the order fulfillment engine 206 has associated one or more suggestions with the item, the interface displayed to the user by the order fulfillment engine 206 displays the one or more suggestions associated with the item. In response to selecting a displayed suggestion, the order fulfillment engine 206 stores the selected suggestion in association with the item and subsequently displays the structured text comprising the selected suggestion to a shopper via a shopper mobile application 112 on a client device of the shopper. Allowing the user to select one or more suggestions comprising structured text reduces an amount of interaction by the user with the customer mobile application 106 to create an order, while displaying the structured text from a selected suggestion to a shopper via the shopper mobile application 112 allows the shopper to more easily identify attributes of an item when obtaining the item by displaying the attributes in a consistent manner for multiple users from the structured text in the suggestion.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the customer 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a customer database 214 which stores information describing each customer. This information could include each customer's name, address, gender, shopping preferences, favorite items, stored payment instruments, and so on.

### Customer Mobile Application

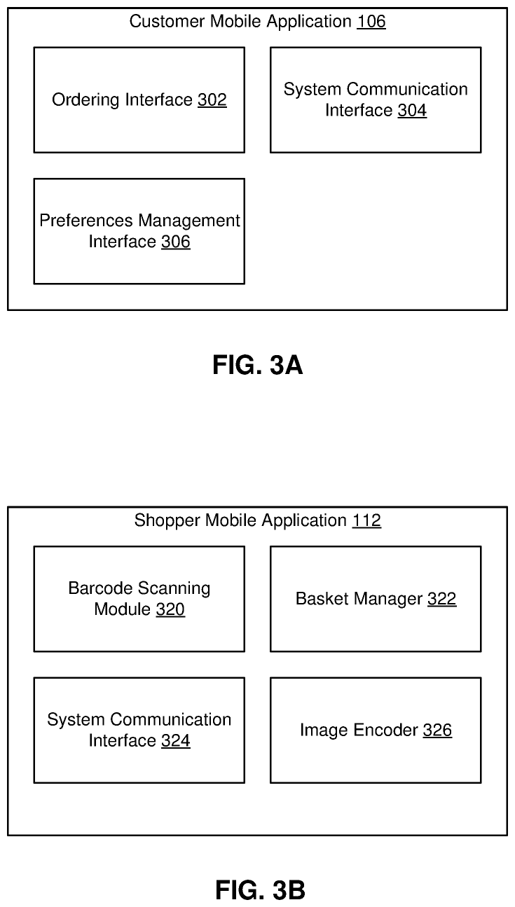

FIG. 3A is a diagram of the customer mobile application (CMA) 106, according to one embodiment. The CMA 106 includes an ordering interface 302, which provides an interactive interface with which the customer 104 (or “user”) can browse through and select items and place an order. In various embodiments, the ordering interface 302 includes an interface element that, when selected by a user, prompts the user to specify one or more attributes of an item included in the order. As further described below in conjunction with FIG. 4, when prompting the user to specify one or more attributes of the item, the ordering interface 302 displays one or more suggestions, each comprising structured text, to the user, allowing the user to select a suggestion to specify one or more attributes of the item. The CMA 106 also includes a system communication interface 304 which, among other functions, receives inventory information from the online shopping concierge system 102 and transmits order information to the system 102. The CMA 106 also includes a preferences management interface 306 which allows the customer 104 to manage basic information associated with his/her account, such as his/her home address and payment instruments. The preferences management interface 306 may also allow the customer to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Generating Structured Text Suggestions for Identifying Attributes of an Item in an Order

FIG. 4 is a flowchart of one embodiment of a method for generating suggestions comprising structured text identifying attributes of an item for selection by a user when creating an order. In various embodiments, the method includes different or additional steps than those described in conjunction with FIG. 4. Further, in some embodiments, the steps of the method may be performed in different orders than the order described in conjunction with FIG. 4. The method described in conjunction with FIG. 4 may be carried out by the online concierge system 102 in various embodiments.

The online concierge system 102 retrieves 405 previously received orders from various users. At least a set of the previously received orders include instructions for one or more items included in a previously received order. As further described above in conjunction with FIG. 2, an instruction for an item specifies one or more attributes the user desires for the item. An instruction for an item includes unstructured text received from the user specifying the one or more attributes of the item. A previously received order stores an instruction in association with the item for which the instruction was received; for example, a previously received order stores an instruction in association with an item identifier that uniquely identifies the item.

While providing instructions for an item allows a user to tailor items obtained by a shopper when fulfilling an order to preferences of the user, entry of unstructured text to provide instructions for the item is time consuming for the user. Additionally, using unstructured text to specify instructions often results in different users identifying similar attributes in different ways, increasing a time for a shopper to determine an attribute of an item when obtaining the item from a warehouse 110. Further, using unstructured text for specifying instructions to a shopper provides the shopper with unclear instructions when the shopper and the user are fluent in different languages, with translations between instructions provided by the user to a language of the shopper potentially introducing discrepancies or errors between the instructions provided by the user and the content presented to the shopper To simplify specification of instructions by users and interpretation of the instructions by shoppers, the online concierge system 102 retrieves 410 instructions previously received for various items from the previously received orders. For example, the online concierge system 410 identifies item identifiers of items included in previously received orders, such as previously received orders received during a specific time interval, associated with instructions received from one or more users.

For an item for which instructions were previously received, the online concierge system 102 extracts 415 one or more specific words from the instructions for the item. For example, the online concierge system 102 extracts 415 specific words occurring in at least a threshold percentage of instructions previously received for the item or occurring with at least a threshold frequency in instructions previously received for the item. In various embodiments, the online concierge system 102 applies one or more natural language processing methods to unstructured text included in different instructions to extract 415 specific words from various instructions received for the item. Alternatively, one or more reviewers of the online concierge system 102 review instructions previously received for the item and extract 415 specific words based on rates at which the specific words occur in instructions previously received for the item. In various embodiments, the online concierge system 102 extracts 415 one or more specific words from instructions previously received for various items. One or more specific words extracted 415 from instructions previously received for an item are stored in association with an item identifier of an item for which the instructions were previously received. Hence, the online concierge system 102 maintains specific words extracted 415 from instructions for various items included in previously received orders by analysis of the instructions previously received for the items. Extracting words from instructions received for an item allows the online concierge system 102 to maintain structured text for the item, with the structured text for the item comprising the specific words extracted 415 from the instructions received for the item.

In various embodiments, the online concierge system 102 identifies words in instructions previously received for various items included in previously received orders and maps words to a uniform terminology. For example, the online concierge system 102 maintains a mapping for various words that maps multiple words to a standardized word, allowing the identification and extraction 415 of specific words in the received instructions to account for variations in how different users identify an attribute of an item. For example, the mapping maintains mappings between a standardized word and one or more synonyms for the standardized word. The synonyms for the standardized word may be identified by one or more users as words or phrases having a common meaning as the standardized word in various embodiments. Words or phrases identified as a synonym for a standardized word may account for an item for which the words or phrases were received; for example, different descriptions of characteristics indicating different items are ripe and mapped to a standardized word of “ripe” in various embodiments. Hence, when the online concierge system 102 identifies one of the synonyms in an instruction, the online concierge system 102 maps the synonym and extracts 415 the standardized word rather than the synonym. This allows the online concierge system 102 to standardize the words extracted 415 from different instructions, accounting for variations in how different users identify attributes of an item so the extracted words are in a uniform terminology, simplifying subsequent review and understanding by users and shoppers.

The online concierge system 102 stores 420 words extracted 415 from previously received instructions for the item in association with the item as suggestions, with each suggestion including one or more of the extracted 415 words. When the online concierge system 102 maps extracted words from previously received instructions to standardized words in a uniform terminology, the online concierge system 102 stores 420 the standardized words corresponding to the words extracted 415 from the previously received instructions in association with the item. This allows the online concierge system 102 to leverage previously received instructions in unstructured text for various items to generate and store 420 one or more words in association with the item for which the one or more words were previously included in instructions. Storing 420 specific words extracted 415 from instructions previously received for the item allows the online concierge system 102 to store 420 suggestions of structured text in association with the item, with each suggestion including one or more specific words extracted 415 from the previously received instructions associated with the item.

In some embodiments, for the item, the online concierge system 102 obtains a shopper-specific description for a word stored 420 in association with the item and in association with the word. The shopper-specific description provides details of the item that indicate attributes of the physical item that satisfy the stored word. For example, the word “ripe” is stored in association with an item of produce and a shopper-specific description for “ripe” identifies physical attributes of the item of produce that indicate ripeness. As different items have different physical characteristics that satisfy a word stored in association with the item, storing shopper-specific descriptions in association with a combination of an item and a word stored 420 with the item allows the online concierge system 102 to display shopper-specific descriptions to a shopper for the combination of the item and the word, providing the shopper with a clear description of how to identify an item that has one or more attributes corresponding to the word. By storing the shopper-specific description in association with the combination of the word and the item, the online concierge system 102 simplifies specification of an instruction for the item by the user, allowing the user to specify the word associated with the item, without increasing complexity for the shopper by displaying the shopper-specific description for the combination of the item and the word to the shopper.

The online concierge system 102 leverages a taxonomy determined for a warehouse 110 to determine whether one or more words extracted 415 from instructions previously received for various items are applicable to other items. Different levels in the taxonomy provide different levels of specificity about items included in the levels. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 matching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from a warehouse 110 in various embodiments. In other embodiments, the online concierge system 102 maintains the taxonomy and applies a trained classification model to an item catalog received from a warehouse 110 to include different items in levels of the taxonomy, so application of the trained classification model associates specific items with generic item descriptions corresponding to levels within the taxonomy.

For an item for which one or more words were extracted 415 from previously received instructions and stores 420 in association with the item, the online concierge system 102 identifies the item in the taxonomy and determines a higher level in the taxonomy that includes the particular item. As further described above in conjunction with FIG. 2, different levels of the taxonomy provide different levels of specificity about items included in the levels. For example, the lowest level in the taxonomy identifies specific items, while a next highest level in the taxonomy identifies a generic item description connected to specific items in the lowest level of the taxonomy. Similarly, another level in the taxonomy higher than the level identifying a generic item description identifies one or more categories, with a category including one or more generic item descriptions. Hence, higher levels in the taxonomy identify a wider range of items that have one or more common attributes. For example, the online concierge system 102 determines a higher level in the taxonomy to which the item is connected; in the preceding examples, the online concierge system 102 identifies a generic item description connected to the particular item via the taxonomy.

From the determined higher level in the taxonomy, the online concierge system 102 identifies one or more alternative items that are also included in the determined higher level. For example, the online concierge system 102 identifies alternative items 430 that are connected to the determined higher level in the taxonomy. This allows the online concierge system 102 to identify alternative items that each have one or more attributes in common with the item because of their common connection to the determined higher level. For example, the online concierge system 102 determines a generic item description connected to the item in the taxonomy and identifies alternative items that are also connected to the determined generic item description in the taxonomy.

The online concierge system 102 compares a word stored 420 in association with the item to words stored 420 in association with the one or more alternative items connected to a common generic item description as the item. In response to determining the word is stored in association with at least a threshold percentage or at least a threshold number of alternative items, the online concierge system 102 stores the word in association with the generic item description that is connected to the item and to the alternative items. In other embodiments, the online concierge system 102 extracts 415 words from instructions previously received for the alternative items, as further described above, and compares the extracted words for the alternative items to the word stored 420 in association with the item. In response to determining the word stored 420 in association with the item was extracted from instructions received for at least a threshold number or at least a threshold percentage of the alternative items connected to a common generic item description as the item, the online concierge system 102 stores the word in association with the generic item description. Subsequently, words stored in association with a generic item description are propagated to each item in a lower level of the taxonomy than the generic item description that are connected to the generic item description, allowing the online concierge system 102 to leverage words extracted 415 from an item for use with other items identified by the taxonomy has having one or more common characteristics with the item. Hence, words associated with an element in the taxonomy are associated with elements in lower levels of the taxonomy connected to the element, allowing the taxonomy to establish a parent-child relationship for association of words stored in association with different levels of the taxonomy.

After storing 420 the extracted words in association with corresponding items, the online concierge system 102 receives 425 a selection of an item for inclusion in a received order from a user. Additionally, the online concierge system 102 receives 430 a request from the user to provide instructions for obtaining the selected item. In response to the request to provide instructions for obtaining the selected item, the online concierge system 102 retrieves words stored in association with the selected item, or in association with a generic item description to which the selected item is connected via the taxonomy and retrieves 435 suggestions for the user. In various embodiments, the online concierge system 102 retrieves 435 the suggestions by identifying words stored 420 in association with the item that were extracted 415 from at least a threshold number of in a threshold percentage of instructions previously received for the item. In another embodiment, the online concierge system 102 retrieves 435 the suggestions by ranking words stored 420 in association with the item or in association with a generic item description in the taxonomy to which the selected item is connected based on corresponding frequencies with which the stored words were extracted from instructions previously received for the item and retrieving 435 suggestions as stored words having at least a threshold position in the ranking. When ranking words stored 420 in association with the item or in association with a generic item description in the taxonomy to which the selected item is connected, the online concierge system 102 may account for whether a word is store 420 in association with the item or is stored 420 in association with a generic item description in the taxonomy to which the selected item is connected. For example, words stored 420 in association with the item have a higher position in the ranking than words stored 420 in association with a generic item description in the taxonomy to which the selected item is connected in some embodiments. The online concierge system 102 may apply one or more diversity criteria when retrieving 435 suggestions for the item, such as retrieving 435 a specific number of suggestions corresponding to words stored 420 in association with a generic item description in the taxonomy to which the selected item is connected as well as suggestions corresponding to words stored 420 in association with the item. As the suggestions are stored 420 in association with a specific item (or with a generic item description or category in the taxonomy associated with various items), the online concierge system 102 leverages an identifier of the item to retrieve suggestions that are stored in association with the item, expediting retrieval of the suggestions for display to the user.

The online concierge system 102 transmits 440 the suggestions to the client device of the user for display in an interface for providing instructions for obtaining the selected item. In various embodiments, the interface includes a text entry field that allows the user to provide unstructured text data as an instruction and displays one or more elements that each display and describe a suggestion. The suggestions may be displayed in a sequence based on one or more criteria in various embodiments. For example, the suggestions are displayed in a sequence based on their frequency of selection by the user, or by other users (e.g., users having one or more common characteristics as the user), with suggestions that are more frequently selected having higher positions in the sequence in various embodiments. However, in other embodiments, the suggestions are displayed in a sequence based on their likelihood of selection by the user (or by other users having one or more common characteristics with the user). As another example, the suggestions are displayed in a sequence based on whether the suggestions correspond to words stored 420 in association with the item or stored 420 in association with a generic item description in the taxonomy to which the selected item is connected, with suggestions corresponding to words stored 420 in association with the item having higher positions in the sequence. The online concierge system 102 may reposition suggestions in the sequence over time based on a frequency with which the user selects different suggestions, allowing the suggestions to be displayed in a sequence where more frequently selected suggestions are more readily accessible. In response to receiving a selection of an element corresponding to a suggestion from the user, the online concierge system 102 stores the selected suggestion in association with the selected item of the order. Hence, rather than manually enter text to provide an instruction, the interface transmitted by the online concierge system 102 allows the user to select a selectable element corresponding to one or more words extracted 415 from previously received instructions from the user, reducing an amount of input from the user to specify instructions for obtaining the selected item.

When a shopper selects the order for fulfillment, the online concierge system 102 transmits 445 one or more extracted words corresponding to the selected selectable element as instructions for obtaining the selected item of the order to a client device of the shopper for display. For example, the instructions for obtaining the selected item are displayed to the shopper via an interface of the shopper mobile application 112 via the client device of the shopper in conjunction with the selected item or in conjunction with information identifying the selected item. In some embodiments, the online concierge system 102 transmits shopper-specific directions associated with the one or more extricated words corresponding to the selected selectable element rather than the one or more extracted words corresponding to the selected selectable element. Hence, the online concierge system 102 provides the shopper with more detailed information for obtaining the selected item and providing shoppers with uniform information for how to obtain the item for the user rather than different instructions created by different users.

The online concierge system 102 may modify the words stored 420 in association with an item based on interactions by users with suggestions corresponding to the words that are displayed to users. For example, the online concierge system 102 determines a number of times various suggestions for an item have been displayed to users, such as a number of times different suggestions have been displayed to users during a specific time interval. Additionally, the online concierge system 102 determines a number of times different suggestions for the item have been selected and determines a frequency with which different suggestions for the item have been selected by one or more users. For example, the online concierge system 102 determines a ratio of a number of times a suggestion for an item was selected by users during a time interval to a number of times the suggestion was displayed to users during the time interval for each of a set of suggestions. The online concierge system 102 removes stored associations between the item and between words corresponding to suggestions having less than a threshold ratio in some embodiments. Alternatively, the online concierge system 102 ranks suggestions based on the determined ratios and removes stored associations between the item and words corresponding to suggestions having less than a threshold position in the ranking. This allows the online concierge system 102 to modify stored associations between words corresponding to suggestions displayed to users and an item based on frequencies with which users interact with displayed suggestions for the items, allowing for more efficient use of storage resources of the online concierge system 102 and simplifying selection of one or more suggestions for obtaining an item by limiting subsequent display of suggestions to suggestions that were selected with at least a threshold frequency.

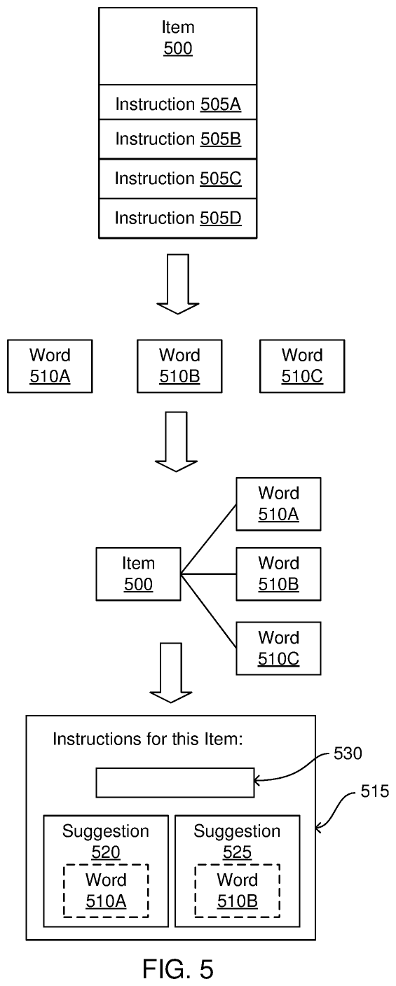

FIG. 5 is a process flow diagram of the online concierge system 102 generating suggestions comprising structured text identifying attributes of an item for selection by a user when creating an order. For an item 500 offered by a warehouse 110, the online concierge system 102 retrieves instructions 505A, 505B, 505C, 505D included in previously received orders that included in the item 500. As further described above in conjunction with FIGS. 2 and 4, instructions for the item 500 identify one or more attributes of the item to be obtained by a shopper. Hence, specifying instructions for an item allows a user to specify particular physical attributes for the item obtained by a shopper when fulfilling an order. For example, instructions specify a color of an item, a firmness of an item, a thickness of an item, or another attribute of a physical item to be obtained for the order. The online concierge system 102 stores received instructions 505A, 505B, 505C, 505D in association with the item 500, maintaining a record of instructions 505A, 505B, 505C, 505D that were received for the item 500 in prior orders.

To simplify specification of instructions for the item, the online concierge system 102 extracts words 510A, 510B, 510C from the received instructions 505A, 505B, 505C, 505D for the item 500. As further described above in conjunction with FIG. 4, the online concierge system 102 extracts words 510A, 510B, 510C appearing with a threshold frequency in the received instructions 505A, 505B, 505C, 505D, appearing in a threshold percentage of the received instructions 505A, 505B, 505C, 505D, or satisfying any other suitable criteria in various embodiments. The online concierge system 102 uses one or more natural language processing models to extract words 510A, 510B, 510C from the received instructions 505A, 505B, 505C, 505D in various embodiments. This allows the online concierge system 102 to leverage the received instructions 505A, 505B, 505C, 505D for the item to identify words that occur in instructions received for the item 500 with at least a threshold frequency. The online concierge system 102 stores associations between the extracted words 510A, 510B, 510C and the item 500.

Subsequently, when the online concierge system 102 receives an order from a user that includes the item 500 and the user requests to provide instructions for obtaining the item 500, the online concierge system 102 transmits an interface 515 for providing the instructions to a client device of the user. The online concierge system 102 leverages the stored associations between the extracted words 510A, 510B, 510C and the item 500 when generating the interface 515 to simplify entry of one or more instructions for the order. As further described above in conjunction with FIG. 4, in various embodiments, the online concierge system 102 includes suggestion 520 and suggestion 525 in the interface 515, with suggestion 520 corresponding to word 510A and suggestion 525 corresponding to word 510B. For example, suggestion 520 displays word 510A, while suggestion 525 displays word 510B; in other embodiments, suggestion 510A displays one or more words or phrases based on word 510A, while suggestion 510B displays one or more words or phrases based on word 510B. Suggestion 520 and suggestion 525 are each displayed as selectable elements in the interface 515, allowing the user to specify suggestion 520 or suggestion 525 as instructions for obtaining the item 500 by selecting a corresponding selectable element. In the example shown by FIG. 5, the interface 515 also includes a text entry element 530 that is configured to receive text input from the user, allowing the user to provide instructions other than those corresponding to suggestion 520 or suggestion 525. While FIG. 5 shows an example interface 515 displaying two suggestions, in other embodiments, the interface 515 displays any number of suggestions. Further, suggestion 520 or suggestion 525 may be displayed in a sequence based on prior selection of suggestion 520 or suggestion 525 by the user to whom the interface 515 is displayed or by other users (e.g., users from whom an order identifying a location in a common geographic region as the user to whom the interface 515 is displayed, users having one or more common characteristics with the user to whom the interface 515 is displayed). Displaying suggestion 520 and suggestion 525 reduces an amount of interaction with the interface 515 for the user to specify instructions for a shopper to obtain the item 500 by leveraging information from previously received instructions for the item 500 that accounts for frequencies with which various words were included in previously received instructions for the item 500.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
retrieving orders previously received by an online concierge system, each order including one or more items;
retrieving instructions for a shopper obtaining an item included in one or more previously received order, each instruction including unstructured text data from a user from whom the previously received order was received;
extracting, by the online concierge system, words from the retrieved instructions based on frequencies with which words occur in the retrieved instructions;
storing the extracted words in association with the item as suggestions that each comprise one or more of the extracted words;
receiving, at the online concierge system, an order from a user that includes the item;
receiving, at the online concierge system, a request from the user to provide instructions for obtaining the order for the received order;
retrieving, by the online concierge system, one or more suggestions from the extracted words associated with the item; and
transmitting an interface including a selectable element corresponding to each of one or more suggestions to a client device of the user.

2. The method of claim 1, further comprising:
receiving a selection of a selectable element corresponding to a suggestion from the client device of the user;
storing one or more extracted words corresponding to the selected selectable element in association with the item and with the order;
receiving, at the online concierge system, a selection of the order for fulfillment by a shopper; and
transmitting the one or more extracted words corresponding to the selectable element stored in association with the item and with the order to a client device of the shopper in conjunction with the order, the one or more extracted words corresponding to the selectable element stored in association with the item and with the order configured for display in conjunction with the item.

3. The method of claim 2, wherein transmitting the one or more extracted words corresponding to the selectable element stored in association with the item and with the order to the client device of the shopper in conjunction with the order comprises:
transmitting a shopper-specific description associated with the one or more extracted words corresponding to the selectable element stored in association with the item and with the order to the client device of the shopper rather than the one or more extracted words corresponding to the selectable element stored in association with the item and with the order, the shopper-specific description providing details of the item that indicate attributes of the physical item satisfying the one or more extracted words corresponding to the selectable element stored in association with the item and with the order.

4. The method of claim 1, wherein storing the extracted words in association with the item comprises:
determining shopper specific descriptions corresponding to each of one or more extracted words; and
storing a shopper specific description in association with a corresponding extracted word associated with the item.

5. The method of claim 1, further comprising:
retrieving interactions by users with selectable elements corresponding to each of one or more suggestions;
determining a number of interactions by users with one or more extracted words corresponding to one or more suggestions during a time interval; and
removing an association between an extracted word and the item in response to a number of interactions with the extracted word being less than a threshold amount.

6. The method of claim 5, wherein removing the association between the extracted word and the item in response to a number of interactions with the extracted word being less than a threshold amount comprises:
removing the association between an extracted word and the item in response to determining a ratio of a number of times a suggestion corresponding to the extracted word was selected during the time interval to a number of times the suggestion corresponding to the extracted word was displayed to users during the time interval being less than a threshold.

7. The method of claim 1, wherein transmitting the interface including the selectable element corresponding to each of one or more suggestions to the client device of the user comprises:
transmitting selectable elements corresponding to suggestions in a sequence, with a position in the sequence of a suggestion based on a frequency with which the user previously selected the suggestion.

8. The method of claim 1, wherein transmitting the interface including the selectable element corresponding to each of one or more suggestions to the client device of the user comprises:
transmitting selectable elements corresponding to suggestions in a sequence, with a position in the sequence of a suggestion based on a frequency with which one or more users having a common characteristic with the user previously selected the suggestion.

9. The method of claim 1, wherein storing the extracted words in association with the item comprises:
retrieving a mapping of words to standardized words in a uniform terminology;
determining a standardized word mapped to an extracted word from the retrieved mapping; and
storing the determined standardized word in association with the item.

10. The method of claim 1, wherein extracting, by the online concierge system, words from the retrieved instructions based on frequencies with which words occur in the retrieved instructions comprises:
extracting words appearing with at least a threshold frequency in the retrieved instructions.

11. The method of claim 1, wherein storing the extracted words in association with the item comprises:
obtaining a taxonomy at the online concierge system, the taxonomy including multiple levels, with different levels providing different levels of specificity about items offered by a warehouse included in the levels;
determining a generic item description at a higher level in the taxonomy than the particular item and connected to the particular item in the taxonomy;
identifying one or more alternative items from the taxonomy, each alternative item coupled to the determined generic item description;
comparing an extracted word associated with the item to extracted words associated with one or more of the alternative items; and
storing the extracted word in association with the generic item description in response to determining the extracted word is stored in association with at least a threshold amount of the alternative items.

12. A computer program product comprising a non-transitory computer readable storage medium having instructions encoded thereon that, when executed by a processor, cause the processor to:
retrieve orders previously received by an online concierge system, each order including one or more items;
retrieve instructions for a shopper obtaining an item included in one or more previously received order, each instruction including unstructured text data from a user from whom the previously received order was received;
extract, by the online concierge system, words from the retrieved instructions based on frequencies with which words occur in the retrieved instructions;
store the extracted words in association with the item as suggestions that each comprise one or more of the extracted words;
receive, at the online concierge system, an order from a user that includes the item;
receive, at the online concierge system, a request from the user to provide instructions for obtaining the order for the received order;
retrieve, by the online concierge system, one or more suggestions from the extracted words associated with the item, each suggestion corresponding to one or more extracted words; and
transmit an interface including a selectable element corresponding to each of one or more suggestions to a client device of the user.

13. The computer program product of claim 12, wherein the non-transitory computer readable storage medium further has instructions encoded thereon that, when executed by the processor, cause the processor to:
receive a selection of a selectable element corresponding to a suggestion from the client device of the user;
store one or more extracted words corresponding to the selected selectable element in association with the item and with the order;
receive, at the online concierge system, a selection of the order for fulfillment by a shopper; and
transmit the one or more extracted words corresponding to the selectable element stored in association with the item and with the order to a client device of the shopper in conjunction with the order, the one or more extracted words corresponding to the selectable element stored in association with the item and with the order configured for display in conjunction with the item.

14. The computer program product of claim 13, wherein transmit the one or more extracted words corresponding to the selectable element stored in association with the item and with the order to the client device of the shopper in conjunction with the order comprises:
transmit a shopper-specific description associated with the one or more extracted words corresponding to the selectable element stored in association with the item and with the order to the client device of the shopper rather than the one or more extracted words corresponding to the selectable element stored in association with the item and with the order, the shopper-specific description providing details of the item that indicate attributes of the physical item satisfying the one or more extracted words corresponding to the selectable element stored in association with the item and with the order.

15. The computer program product of claim 12, wherein store the extracted words in association with the item comprises:
determine shopper specific descriptions corresponding to each of one or more extracted words; and
store a shopper specific description in association with a corresponding extracted word associated with the item.

16. The computer program product of claim 12, wherein the non-transitory computer readable storage medium further has instructions encoded thereon that, when executed by the processor, cause the processor to:
retrieve interactions by users with selectable elements corresponding to each of one or more suggestions;
determine a number of interactions by users with one or more extracted words corresponding to one or more suggestions during a time interval; and
remove an association between an extracted word and the item in response to a number of interactions with the extracted word being less than a threshold amount.

17. The computer program product of claim 16, wherein remove the association between the extracted word and the item in response to a number of interactions with the extracted word being less than a threshold amount comprises:
remove the association between an extracted word and the item in response to determining a ratio of a number of times a suggestion corresponding to the extracted word was selected during the time interval to a number of times the suggestion corresponding to the extracted word was displayed to users during the time interval being less than a threshold.

18. The computer program product of claim 12, wherein transmit the interface including the selectable element corresponding to each of one or more suggestions to the client device of the user comprises:
transmit selectable elements corresponding to suggestions in a sequence, with a position in the sequence of a suggestion based on a frequency with which the user previously selected the suggestion.

19. The computer program product of claim 12, wherein transmit the interface including the selectable element corresponding to each of one or more suggestions to the client device of the user comprises:
transmit selectable elements corresponding to suggestions in a sequence, with a position in the sequence of a suggestion based on a frequency with which one or more users having a common characteristic with the user previously selected the suggestion.

20. The computer program product of claim 12, wherein store the extracted words in association with the item comprises:
retrieve a mapping of words to standardized words in a uniform terminology;
determine a standardized word mapped to an extracted word from the retrieved mapping; and
store the determined standardized word in association with the item.

21. The computer program product of claim 12, wherein extract, by the online concierge system, words from the retrieved instructions based on frequencies with which words occur in the retrieved instructions comprises:
extract words appearing with at least a threshold frequency in the retrieved instructions.

22. The computer program product of claim 12, wherein store the extracted words in association with the item comprises:
obtain a taxonomy at the online concierge system, the taxonomy including multiple levels, with different levels providing different levels of specificity about items offered by a warehouse included in the levels;
determine a generic item description at a higher level in the taxonomy than the particular item and connected to the particular item in the taxonomy;
identify one or more alternative items from the taxonomy, each alternative item coupled to the determined generic item description;
compare an extracted word associated with the item to extracted words associated with one or more of the alternative items; and
store the extracted word in association with the generic item description in response to determining the extracted word is stored in association with at least a threshold amount of the alternative items.
